(19) United States
(12) Patent Application Publication
(10) Pub. No.: US 2019/0066117 A1
(43) Pub. Date: Feb. 28, 2019

(54) OMNI-CHANNEL SYSTEM SCORING ANALYTICS

(71) Applicant: NCR Corporation, Duluth, GA (US)

(72) Inventor: Justin Ryan Fortin, Atlanta, GA (US)

(21) Appl. No.: 15/691,116

(22) Filed: Aug. 30, 2017

(51) Int. Cl. G06Q 30/00

(52) U.S. Cl. CPC G06Q 30/016

(57) ABSTRACT

Various embodiments herein each include at least one of systems methods, and software for omni-channel system score analytics. One embodiment, in the form of a method includes storing transaction data of a plurality of transactions processed on a hosted computing system that services transactions for a plurality of entities. This method further includes receiving a score request over a network from a requestor and processing transaction data associated with a group of transactions to generate a score according to the request. The method may then transmit the score over the network to the requestor.

### BACKGROUND INFORMATION

Often when a customer arrives in a store or restaurant, or other point of sale such as a website of an online retailer, a kiosk, and the like, little is known of the person. It is quite possible that person could be a wonderful customer while the person could instead be a difficult customer or somewhere in between. Retailers generally accept any customer, but knowing customer tendencies can be helpful, such as being likely to return many purchases, to have warranty issues, to make help-line calls, or to quickly return to purchase additional ancillary items for a purchased product. Such knowledge can be useful to improve customer experiences, prevent issues likely to arise, increase profitability, and to achieve other such goals.

### SUMMARY

Various embodiments herein each include at least one of systems methods, and software for omni-channel system score analytics. One embodiment, in the form of a method includes storing transaction data of a plurality of transactions processed on a hosted computing system that services transactions for a plurality of entities. This method further includes receiving a score request over a network from a requestor and processing transaction data associated with a group of transactions to generate a score according to the request. The method may then transmits the score over the network to the requestor.

Another method embodiment includes processing transaction data associated with a group of transactions to generate a score according to a request received from a requestor. This method may then transmit the score to the requestor.

A further embodiment is in the form of a system. The system of such embodiments includes at least one processor, at least one network interface device, and at least one memory device. The at least one memory device store instructions executable by the at least one processor to cause the system to perform data processing activities. The data processing activities may include storing, on the at least one memory device, transaction data of a plurality of transactions processed on a hosted computing system that services transactions for a plurality of entities. The data processing activities further include receiving a score request via the network interface device from a requestor and processing transaction data associated with a group of transactions to generate a score according to the request. The data processing activities in some such embodiments may further include transmitting the score via the network interface device to the requestor.

### BRIEF DESCRIPTION OF THE DRAWINGS

FIG. 1 is a system architectural diagram according to an example embodiment.

FIG. 2 is a logical block diagram of a method, according to an example embodiment.

FIG. 3 is a logical block diagram of a method, according to an example embodiment.

FIG. 4 is a block diagram of a computing device, according to an example embodiment.

### DETAILED DESCRIPTION

Currently when customers submit an order to a restaurant or a merchant, there is no validation that this customer is a real customer who is planning on paying for their order and picking it up, or if the customer is likely to make a large number of returns, or any other undesirable behavior. The business accepting the order rarely has information about how likely the order is to be bad or about the reputation of the customer. This leaves the business open to fraud or abuse, with no advance notice that there is any potential issue with the customer. The embodiments herein operation to provide insight into such issues in the form of data that may be acted upon based on rules and other solutions that the business may choose to develop to meet their needs to prevent unwanted customer behavior, increase customer satisfaction, decrease loss and returns, and increase profitability.

For example, with the advent of the multi-channel platforms, such as the Omni-Channel Decision Support Platform available from NCR Corporation of Duluth, Ga., and the fact that customer data processed through such systems is typically stored in the same place, an ability is provided to perform data analytics on this information to gain insight. Such solutions as described herein allow analysis with regard to a customer's history across multiple merchants for things that may lower their reputation, such as a large number of incomplete orders, returns, unpaid orders, a number of complaints, calls to tech support or customer service, and the like. At the same time, positive interactions may also be tracked, such as timely payments, praiseworthy feedback on products or services, limited or no returns, an amount of money spent with the merchant, and the like. This data be leveraged to allow any business processing the order to make an informed decision about whether the customer needs additional verification or support for orders they place, such as recommendations or suggestions with other ancillary products (e.g., batteries, cords, extended warranties) that may resolve potential issues.

Some such embodiments allow for tracking an individual customer's past performance to give the company the order was submitted to insight on the risk profile of the customer. The tracking of individual customers may be performed based on know data unique to the customer, such as a credit card number, address, globally unique identifier (GUID) of a computer or mobile device of the customer, a loyalty program identifier, userid and password, and other such identification solutions.

The customer risk or reputation information may be provided as a score, as a simple red/green or other Boolean status, a probability, a letter grade, or other output depending on the level of detail of the analytics process. Because this analysis is performed, in some embodiments, across multiple merchants hosted by a common platform (e.g., a cloud-based solution), this information may be provided even if this is the customer's first order at that location or with the particular retailer. This information may be surfaced or otherwise provided to business using platform technologies without any additional effort as the existing services on the hosted platform may be integrated with the risk profile information to provide this insightful data. For example, if a business was using the omni-channel order service, their software may be updated to automatically display risk profile information with an associated order that the business has just received without having to go out of their way to find the information. This information may be displayed to a store clerk on a terminal or mobile device used in conducting a transaction. This information may instead be consumed by a process of a web or app-based ecommerce solution to modify the transaction in some way, such as to recommend other products that are commonly needed, offer an extended warranty, offer an opportunity to speak with customer service about the product before purchasing, and the like.

Customers past history across the omni-channel platform may be used in some such embodiments to calculate the customer risk profile according to a standard rule, a rule selected by the retailer, or a rule custom-defined by the retailer. If a customer has had any prior events that a retailer may consider undesirable, such as a high number of returns, canceled orders, rejected payments, unpaid orders, or complaints, their score may be adjusted to indicate higher risk. If a customer had enough of those events, it could potentially red-flag that customer in the platform so that when they do any future interaction with a business, the business is informed of the customer's past such that the business may take alternative actions. Additionally, because the goal of some multi-channel embodiments is to be the central location for all customer interaction across any channel and a large number of businesses, such embodiments may employ big data analytics to uncover anomalous behavior and find customers that exhibit unusual behavior in ways that were not being specifically sought. As a customer performs more transactions through the platform in the future, the risk profile may be updated to reflect those transactions or to take into account only most recent transaction so that the most relevant information to the business is considered and can be acted upon.

At the same time, some embodiments may operate to identify positive events to build the customer reputation positively or based on a combination of positive and negative events. For example, a customer that has a significantly lower number of returns/failed payments/etc. in their history, a retailer could provide them preferential treatment. For example, if a customer has never had a failed payment and only rarely performs a return or needs additional help, a business could use that information to choose to offer that customer a discount or similar special consideration. The goal of the such embodiment is not necessarily decide for the retailer how to handle customers differently, but to provide insight to make the decision on how to handle an individual customer.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

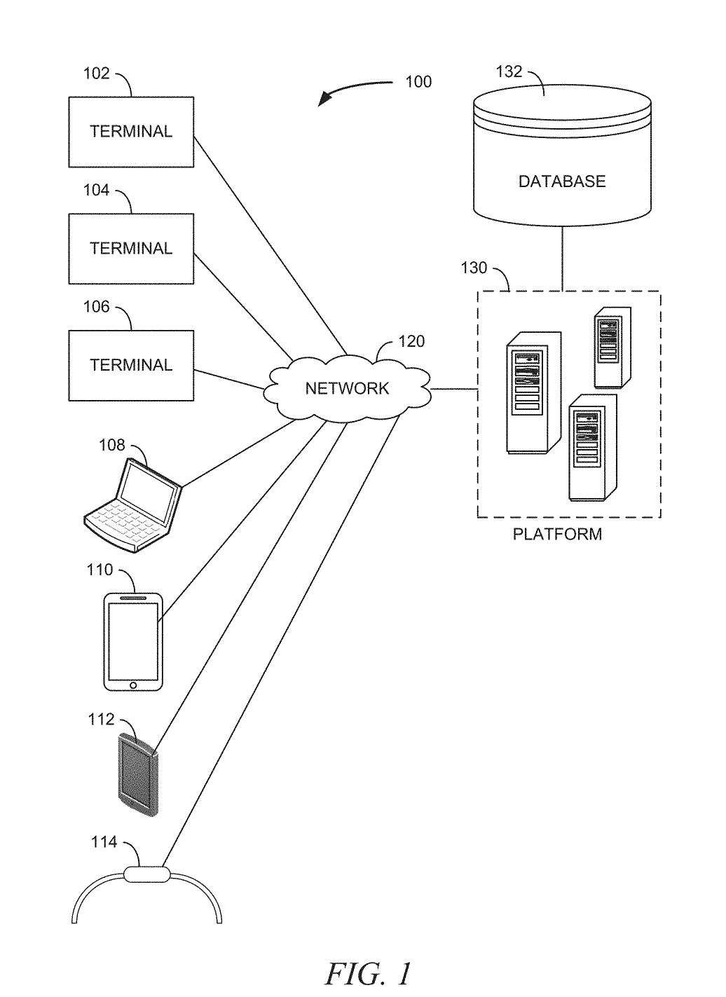

FIG. 1 is a system 100 architectural diagram according to an example embodiment. The system 100 is an example of a system on which omni-channel, or multi-channel, system scoring analytics embodiments may be implemented.

The terms omni-channel and multi-channel are intended as synonymous and are used interchangeably at times. These terms mean that customer transactions may occur via any number of channels, such as at terminals 102, 104, 106, which may be of various types. For example, the terminals 102, 104, 106 may include one or more of teller-assisted point-of-sale (POS) terminals, self-service terminals (SST) which may be POS SSTs, personal computers 108, a mobile telephone 110, a tablet 112, a smart watch 114, among others. Other channels may include set top boxes (STBs), smart-controllers of other devices or machines such as automobiles, boats, and tractors, vehicle entertainment systems, and others.

Each of the channels 102, 104, 106, 108, 110, 112, 114 generally provides a mechanism, such as an app or application or a web browser through which an electronic commerce web may be viewed and interacted with, that allows the user to conduct electronic commerce with retailers, which may include restaurants, stores that sell goods and services, service providers, and the like.

Regardless of the particular channel, a computing device of each respective channel 102, 104, 106, 108, 110, 112, 114 connects to a network 120. The network 120 may include one or more network-types, such as Ethernet, WI-FI, 3G and 4G wireless networks, 5G wireless networks, virtual private networks (VPNs), the Internet, a local area network, a wide area network, a proprietary network, a mesh network, among others in various embodiments.

Also connected to the network 120 is an omni-channel platform 130, or more simply referred to herein as a platform 130. The platform 130 provides a cloud-based solution for retailers to support the channels over which they interact with customers, either indirectly with teller-assisted channels or through direct customer interaction such as though SST channels (e.g., automated teller machines, self-service checkout POS terminals, etc.) or customer browser, app, or application-based channels. The platform 130 provides services, such as transaction and payment processing services, customer loyalty services, customer relationship management (CRM) services, transaction data archiving, customer communication services, among others. Another service offered by the platform 130 is omni-channel scoring analytics, such as to provide a customer reputation scoring based on historic transaction data of the customer across all entities that subscribe to the services of the platform 130.

The system 100 also includes a database 132, which may in some embodiments be more than one database 132. Regardless, the database 132 is connected or is otherwise accessible to the platform 130. The database 132 stores configuration data, content data, product data, customer data, and other data, in various embodiments, depending on the services offered by the platform 130 in the particular embodiment. Note that a retailer need not subscribe to all services of the platform 130 to integrate with and utilize the platform 130.

The system 100 in operation includes retailers conducting or receiving transactions via one or more of the channels 102, 104, 106, 108, 110, 112, 114. As the transactions are conducted, the channels 102, 104, 106, 108, 110, 112, 114 communicate over the network 120 with the platform 130. The platform 130 provides its services to the retailers for conducting their transactions and stores transaction data in the database 132. Overtime, the platform 130 becomes aware of many individual customers based on their transaction data that is received from many retailers and stored in the database 132. Customers can be uniquely identified in this data a number of ways, such as by loyalty account information, phone numbers, credit card numbers, globally unique identifiers (GUIDs) or other unique device identifiers of devices associated with a customer, phone numbers, and the like. Relationships between such identifier may also be identified thereby providing the platform 130 a group of unique identifiers associated with a single customer thereby increasing the opportunities to uniquely identify a customer.

Once a customer can be uniquely identified, transactions of the that customer can then be identified along with follow on interactions with regard to an identified transaction such that the entire transaction lifecycle may be considered. This may allow for identifying product returns, complaints, help desk or customer service support calls, warranty claims, missed payments, returned payments, denied credit or debit payments, and other such occurrences. These may be considered as negative value events. Positive value events may also be considered such as purchase of extended warranty plans, positive product or service reviews from the customer, on-time payments, a small number of product returns, and the like. Thus, with regard to a customer, once uniquely identified, positive and negative value transaction events can be identified and used in generating a customer score, which may be considered a customer reputation.

A customer score can be used for many purposes, such as giving a clerk insight to expect the customer to be difficult to communicate with or to be quite friendly. Another purpose may be to determine whether the customer is likely to have warranty issues, and if so, to offer an extended warranty. A customer may also have a high frequency of return trips to the retailer soon after purchases for ancillary items, such as cords, condiments, batteries, and the like and the score may be used to assist a teller in providing guidance or asking prompting questions to help the customer eliminate the need for a follow visit to the store and thereby enhancing the customer experience.

As each retailer is unique in some way, the platform 130 may provide retailers the ability in some embodiments to not just select predefined, stock rules, but also to define rules for events to considered, values associated with particular event types, score weightings, and score summation formulas. Further, some embodiments allow retailers to define a plurality of scoring algorithms that are each tailored to specific purposes, such as one rule to score a customer's likelihood of returning products and another score indicating the customer's likelihood of complaining. These scores may be provided by the platform 130 for presentation on a teller-assisted channel 102, 104, 106, 108, 110, 112, 114 device or for consumption by a process of another platform 130 service or a non-teller assisted channel 102, 104, 106, 108, 110, 112, 114, such as an app or SST.

Regardless of the score and how the score is calculated or how it is used, the score may be calculated from a retailer's own data or data of many or all retailers that subscribe to the services of the platform 130. When considering customer data from many retailers, the actually customer data is not shared. The data processing occurs on the computing device(s) on which the platform is deployed and only score data derived from that processing is provided. The score is an abstraction that is derived from the underlying data and not the customer data itself.

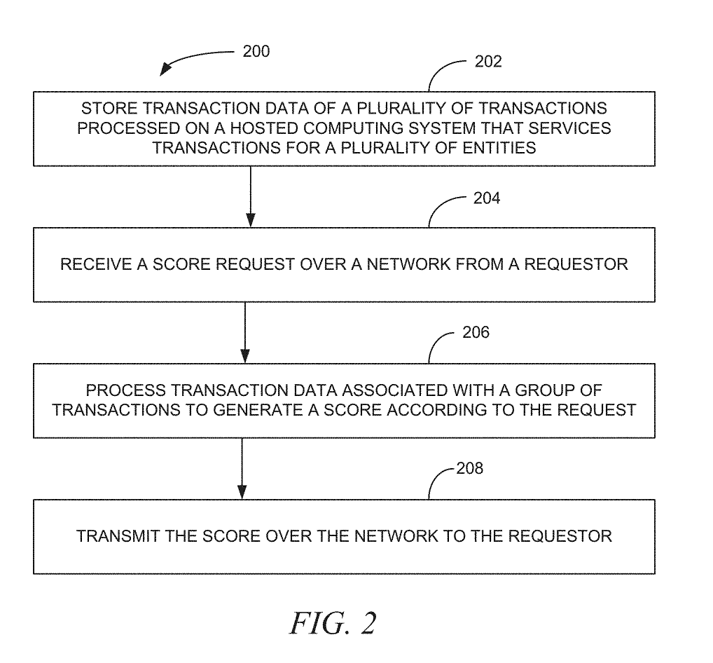

FIG. 2 is a logical block diagram of a method 200, according to an example embodiment. The method 200 is an example of a method that may be performed, such as on platform 132 of FIG. 1, to implement omni-channel system scoring analytics.

The method 200 includes storing 202 transaction data of a plurality of transactions processed on a hosted computing system that services transactions for a plurality of entities. The method 200 further includes receiving 204 a score request over a network from a requestor and processing 206 transaction data associated with a group of transactions to generate a score according to the request. The method 200 may then transmit transmitting 208 the score over the network to the requestor, such as a channel terminal. The method 200 may alternatively provide the score to another process that considers the score to determine another data processing action to perform or forebear from performing.

In some embodiments of the method 200, the group of transactions consists essentially of transactions associated with a particular customer identified in the request.

In some embodiment, the method 200 further includes generating the score based on an aggregation of score elements defined by one or more scoring rules defined for the requestor from which the score request was received. One or more of such scoring rules may include at least one rule identifying transaction data types to be scored and of which, at least one rule may define how scores generated for each scored transaction are to be aggregated. In some such embodiments, at least one rule identifies relevant transaction types for application of the respective rule. In another embodiment, the one or more scoring rules may further include at least one rule providing assignments of values to the transaction data types that are to be scored, the values to be aggregated by the at least one rule defining how scores generated for each scored transaction are to be aggregated.

The requestor, in some embodiments of the method 200, is a computing process executing for one of the plurality of entities with regard to an open transaction that is being conducted. The open transaction, in some such embodiments, is conducted on the hosted computing system and the score request is received with other transaction data within the open transaction.

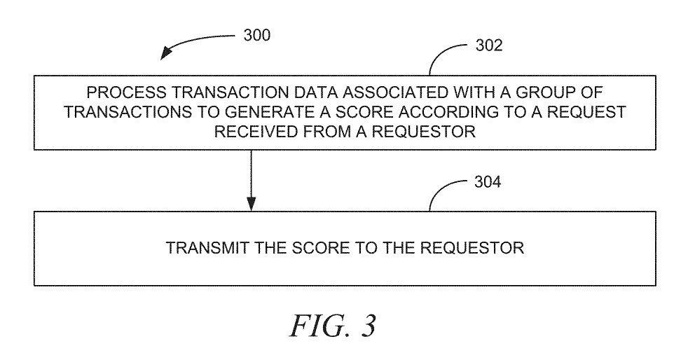

FIG. 3 is a logical block diagram of a method 300, according to an example embodiment. The method 300 is another example of a method that may be performed, such as on platform 132 of FIG. 1, to implement omni-channel system scoring analytics.

The method 300 includes processing 302 transaction data associated with a group of transactions to generate a score according to a request received from a requestor. The method 300 may then transmit the score to the requestor.

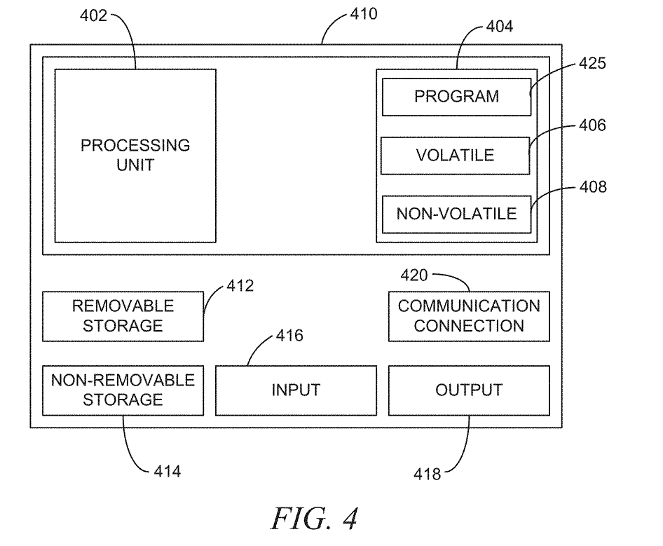

FIG. 4 is a block diagram of a computing device, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a non-transitory computer-readable medium. For example, a computer program 425 capable of performing one or more of the methods described herein may be stored on a non-transitory computer readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
storing transaction data of a plurality of transactions processed on a hosted computing system that services transactions for a plurality of entities;
receiving a score request over a network from a requestor;
processing transaction data associated with a group of transactions to generate a score according to the request; and
transmitting the score over the network to the requestor.

2. The method of claim 1, wherein the group of transactions consists essentially of transactions associated with a particular customer identified in the request.

3. The method of claim 1, further comprising:
generating the score based on an aggregation of score elements defined by one or more scoring rules defined for the requestor from which the score request was received.

4. The method of claim 3, wherein the one or more scoring rules include:
at least one rule identifying transaction data types to be scored; and
at least one rule defining how scores generated for each scored transaction are to be aggregated.

5. The method of claim 4, wherein at least one rule identifies relevant transaction types for application of the respective rule.

6. The method of claim 4, wherein the one or more scoring rules further include:
at least one rule providing assignments of values to the transaction data types that are to be scored, the values to be aggregated by the at least one rule defining how scores generated for each scored transaction are to be aggregated.

7. The method of claim 1, wherein the requestor is a computing process executing for one of the plurality of entities with regard to an open transaction that is being conducted.

8. The method of claim 7, wherein the open transaction is conducted on the hosted computing system and the score request is received with other transaction data within the open transaction.

9. A method comprising:
processing transaction data associated with a group of transactions to generate a score according to a request received from a requestor; and
transmitting the score to the requestor.

10. The method of claim 9, wherein the group of transactions includes transactions associated with a particular customer identified in the request.

11. The method of claim 9, wherein the score is generated based on an aggregation of score elements defined by at least one scoring rule defined for the requestor from which the score request was received.

12. The method of claim 11, wherein the at least one scoring rule includes:
at least one rule identifying transaction data types to be scored; and
at least one rule defining how scores generated for each scored transaction are to be aggregated.

13. The method of claim 12, wherein at least one rule identifies relevant transaction types for application of the respective rule.

14. The method of claim 12, wherein the at least one scoring rule further includes:
at least one rule providing assignments of values to the transaction data types that are to be scored, the values to be aggregated by the at least one rule defining how scores generated for each scored transaction are to be aggregated.

15. The method of claim 9, wherein the requestor is a computing process executing for one of a plurality of entities with regard to an open transaction that is being conducted on a hosted computing system on which the method is performed at least in part.

16. The method of claim 15, wherein the open transaction is conducted on the hosted computing system and the score request is received with other transaction data within the open transaction.

17. The method of claim 9, wherein the requestor is a process that executes on a terminal within a retailer facility.

18. A system comprising:
at least one processor, at least one network interface device, and at least one memory device storing instructions executable by the at least one processor to cause the system to perform data processing activities comprising:
storing, on the at least one memory device, transaction data of a plurality of transactions processed on a hosted computing system that services transactions for a plurality of entities;
receiving a score request via the network interface device from a requestor;
processing transaction data associated with a group of transactions to generate a score according to the request; and
transmitting the score via the network interface device to the requestor.

19. The system of claim 18, further comprising:
generating the score based on an aggregation of score elements defined by one or more scoring rules defined for the requestor from which the score request was received; and
wherein the one or more scoring rules include:
at least one rule identifying transaction data types to be scored; and
at least one rule defining how scores generated for each scored transaction are to be aggregated.

20. The system of claim 20, wherein the system is the hosted computing system.
